(19) United States
(12) Patent Application Publication
(10) Pub. No.: US 2009/0287733 A1
(43) Pub. Date: Nov. 19, 2009

(54) Method for preparing prepress image data

(76) Inventors: Chanan Steinhart, Palo Alto, CA (US); Yishai Steinhart, Palo Alto, CA (US)

Correspondence Address: NORMAN FRIEDLAND, 2855 PGA BOULEVARD, SUITE 200, PALM BEACH GARDENS, FL, 33410, US

(21) Appl. No.: 12/152,523

(22) Filed: May 15, 2008

(51) Int. Cl. G06F 17/30

(52) U.S. Cl. 707/102; 707/100; 707/E17.019

(57) ABSTRACT

A method for preparing prepress image data includes forming low-resolution versions of the image data and laying out a document in a page layout program. Data describing commands manipulating the images and placing the images within a document is embedded within the metadata, and preferably within the Exif section of the megadata, of the low-resolution image files for subsequent use in manipulating and placing high-resolution versions of the images before printing the document. Alternately, high-resolution image data may be placed according to the placement of low-resolution image data by a conventional image editor.

### RELATED APPLICATIONS

Not Applicable

### FEDERALLY SPONSORED RESEARCH OR DEVELOPMENT

Not Applicable

### BACKGROUND OF THE INVENTION

1. Field of the Invention

This invention relates to a method for preparing prepress data and, more particularly, to such a method using low-resolution digital images in page layouts.

2. Summary of the Background Information

In 1989, the Open Prepress Interface (OPI) was established to provide a solution to one of the most common problems encountered when working in a graphic design environment—the problem of producing a file having a very large size resulting from including a number high-resolution bitmaps within the file. Open Prepress Interface (OPI) is a collection of PostScript language comment conventions, which describe the placement and size of images, as well as cropping information and any adjustments to other attributes of the images, that uses low-resolution-placeholders for large images in order to speed layout and proofing and to conserve disk space when working in a page layout program such as Adobe® PageMaker® or Adobe InDesign®. For example, an OPI workflow can use low or medium resolution TIFF images for page layout and proofing in an application like InDesign, and then use a prepress system or OPI server to substitute high-resolution versions of the images when the final print output is generated. In addition to saving time and disk space, OPI helps desktop prepress software and high-end prepress systems to minimize network traffic and image storage requirements.

FIG. 1 is a data flow chart of a first conventional prepress page layout process 10 including the OPI interface. Input data for this process, in the form of high-resolution input data files 12, is stored in an input database 14, having been transmitted from input sources 16, such as a scanner 18, a digital camera 20, a graphics design program 22, such as Adobe® Illustrator®, or an image editor program 24, such as Adobe® Photoshop®.

A page layout program 30, such as Adobe® InDesign® is used to layout one or more pages to be printed, with the page(s) including images from the high-resolution input data files 12, selected by the user in step 32 from the files stored within the input database 14. The files stored within the input database 14 are high-resolution files, which are needed to provide a desired level of image quality for the printing process. In step 34, low-resolution data files 36 representing the images of the high-resolution images of input files 12 are generated, according to the OPI process, for use as placeholders in the page layout process, since the high-resolution image is not needed for placement and manipulation. For example, the low-resolution files 36 are TIFF (Tagged Image File Format) that are versions of TIFF files forming the high-resolution input files within input files 12.

Then, in step 38, the user manipulates images produced and displayed by the page layout program 30, using the low-resolution image data files 36. These manipulations, which include, for example, a placing the images on the page(s) being laid out, moving, and cropping the images are performed using tools of the page layout program 30. In step 40, the page layout program 30 generates OPI comments, including the file name and position of each image placed on the page(s) being laid out, cropping information, and any other changes made to the data describing each image by the user in step 38 Then, in step 42, a PostScript® file 44 is generated, including the comments generated in step 40. The user can also add text information The step 42 may also include the incorporation of text data into the PostScript file 44 from a text file 46, which is generated by user input 48 through the keyboard (not shown) of the system running the page layout program 30 and/or by data imported from a word processor program 50, such as Microsoft® Word®. Since this PostScript file 44 generally does not include any image data it is typically a small file.

For example, the PostScript file 44 is stored within a database 52 to be loaded into an OPI server 56 when the server 56 becomes available. Then, when the OPI server 56 receives the PostScript file 44, the OPI comments are extracted, and the file names associated with the images that are used in the page(s) to be printed are used to define server selections 58 from high-resolution files stored within the image database 14. The selected high-resolution files 60 are then transmitted to the OPI server 56 where the OPI layout information is extracted and used to find high-resolution image data files 60, which are then sent to a PostScipt RIP 62 (Raster Image Processor) associated with the printer 64. The PostScript RIP 62 then applies information derived from the O[I comments describing the cropping, location, and other modifications made to the images to place and modify the images then printed by the printer 64.

FIG. 2 is a data flow chart of a second conventional prepress page layout process 70, with input data for the process 70 being stored in the form of Encapsulated PostScript (EPS) files 72 stored within an input database 74. Each of the EPS files 72 includes both high-resolution image data 76 in the PostScript format, which is used for printing, and low-resolution data 78, which is used for display purposes, and, in the case of this layout process 70, for image placement. The low-resolution image data 78 consists of bitmap data, typically in a TIFF format, while the high-resolution image data 76 either of bitmap image data or of vector image data in a format defined within PostScript specifications.

Input data files may be provided by a number of data sources 80, which are similar to the input devices uses in the process of FIG. 1. However, it is noted that, in the case of the process 70 of FIG. 2, an EPS file must be produced. In the example of FIG. 2, it is assumed that the image editor 82 and the graphics design program 84 each have a capability for producing EPS files, with these data sources 82, 84 being, for example, Adobe Photoshop and Adobe Illustrator, respectively. The output files from the scanner 86 and the digital camera 88 are provided as inputs alternately to a data reformatting program 90, such as Adobe® Acrobat®, which produces EPS files, or to the image editor program 82, which can be used to enhance the images from the scanner 86 and the digital camera 88 before producing EPS files as outputs.

Within a page layout program 92, such as Adobe InDesign, the low-resolution image data files 78 within EPS files 72 selected by the user in step 94 from the files stored within the EPS file database 74, are manipulated by the user in step 96, with the manipulations including, for example, placing the images in particular locations on the pages being laid out and resizing and cropping the images. In step 98, OPI commands corresponding to the user manipulations of step 96 are generated. In step 100, the high-resolution data portions 76 of the EPS files 72 are replaced with the OPI commands 102 generated in step 98, forming output EPS files 104, which are stored in an output database 106. The output EPS files 104 additionally include information locating the corresponding EPS files 72 stored within the input database 74.

If text is to be included within the page(s) being laid out, a text file 108 is generated within the page layout program 92, either using input data provided by the user in step 110 through the keyboard (not shown) of the computer system executing the page layout program 96 or through the importation of text data from a word processor 112.

When an OPI server 116 becomes available, output EPS files 104 are transmitted to the OPI server 116. Then, the file names associated with the images that are used in the page(s) to be printed are used to define server selections 118 from the input EPS files 72 stored within the input database 74. The selected EPS files 120 are then transmitted to the OPI server 116 where the OPI layout information from the output EPS files 104 is sent to a PostScipt RIP 122 (Raster Image Processor) associated with a printer 124. The PostScript RIP 124 then applies information derived from the OPI comments describing the cropping, location, and other modifications made to the images to place and modify the images then printed by the printer 124.

From the patent literature, U.S. Pat. App. Pub. No. 2002/0057441A1, describes the addition of image caching to the OPI process. The OPI commands for manipulating an image are applied to high-resolution image data, which is copied to storage before it is applied to the printing process through a PostScript interpreter. The advantage is that, if a change has to be made to a portion of a page other than the image after the page is initially printed, the process of manipulating the high-resolution image does not need to be repeated.

U.S. Pat. No. 7,069,314 describes the use of an OPI daemon within a server forming an OPI interface, with the daemon monitoring OPI configuration folders, to which the user has copied an authentication file giving instructions for the folder to be managed as an OPI folder in which the OPI functions can be utilized. On the server, the daemon registers the folder in an OPI database and performes a process for issuing a folder ID so that the folder is managed as the OPI folder, This method precludes a need to develop exclusive-use software for each type of clients and to install exclusive-use software in each client.

The prior-art processes described above share a serious limitation in that a proprietary PostScript process is required. While the PostScript process is used in a high-volume portion of the commercial printing industry, a significant number of printing systems do not use a PostScript RIP and are therefore precluded from a workflow including the benefits of OPI. For successful operation of the prior-art OPI processes, the document producing application has to be well aware of, and involved in, the output printing process, so that the relevant PostScript commands are generated and passed along correctly to generate the PostScript data stream transmitted to the printer.

Furthermore, the EPS file format, which is used as described above in reference to FIG. 2, is not commonly supported outside high-volume publishing. For example, the EPS file format is not supported major web browsers and by many application programs used in the generation and printing of documents.

What is needed is a method for providing the efficiencies of the OPI process in a workflow using a printer without PostScript capability, using, for example, the JPEG file format. For example, such a printer may be used within a PDF workflow.

### SUMMARY OF THE INVENTION

In accordance with a first aspect of the invention, a method is provided for preparing prepress image data, wherein the method comprises:

receiving a user selection of a plurality of images;

loading a high-resolution input data file for each image within the plurality of images, wherein each of the high-resolution data files includes an image data section storing data describing a high-resolution version of the image;

receiving user inputs selecting images within the plurality of images within a document, and displaying the images selected, derived from the data describing a low-resolution version of each images,

generating a low-resolution input data file corresponding to each of the high-resolution data files, wherein each of the low-resolution data files includes an image data section, storing data describing a low-resolution version of the image, and a metadata section for storing non-image data;

receiving user inputs modifying the images displayed on a display of the document, modifying displayed versions of the images according to the user inputs modifying the images, and generating commands describing modifications of the images; and

forming a low-resolution output data file for each image by embedding data describing the commands describing modifications of the image and information describing a location of a high-resolution image file including data describing a high-resolution version of the image in the metadata section of the low-resolution image data file additionally having the image data section storing data describing a low-resolution version of the image.

The method may additionally comprise:

receiving user inputs placing images within the plurality of images within a document, displaying the images, derived from the data describing a low-resolution version of each images, on a display of the document according to the user inputs, and generating commands describing the placement of images according to the user inputs;

embedding data describing the commands describing the placement of each image within the document in the metadata section of the low-resolution image data file additionally having the image data section storing data describing a low-resolution version of the image within the low-resolution output data file.

reading the data describing the commands describing the placement of each image within the document, the data describing the commands describing modifications of the image, and the information describing a location of a high-resolution image file including a high-resolution version of the image from the metadata section of each low-resolution data file;

retrieving the high-resolution image file including a high-resolution version of the image using information read from the metadata of each low-resolution data file; and

generating a document data file for printing including an embedded high-resolution image file for each image, located and modified according to commands read from the metadata of each low-resolution data file.

Alternately, the method may additionally comprise:

transmitting a plurality of the low-resolution output data files over a network to an image editing system at a remote location

generating a document data file including an embedded low-resolution version of each image stored within the low-resolution output data files within the image editing system;

transmitting the document data file and the low-resolution output data files to a print server system;

reading, within the print server system, the data describing the commands describing modifications of the image, and the information describing a location of a high-resolution image file including a high-resolution version of the image from the metadata section of each low-resolution data file;

retrieving the high-resolution image file including a high-resolution version of the image using information read from the metadata of each low-resolution data file; and

generating a data file for printing including an embedded high-resolution image file for each image, located according to the location of the embedded low-resolution version of each image within the document data file and modified according to commands read from the metadata of each low-resolution data file.

Preferably, the commands are embedded within a portion of the metadata conventionally reserved for storing Exif data describing a device used to form the image, without adding metadata tags, with each of the data files is written in a file format providing data compression, taken from a group consisting of the JPEG file format and the TIFF file format.

According to another aspect of the invention, memory is provided for storing data for access by an application program being executed on a computer system, comprising a data structure stored in the memory, the data structure including:

an image data section including image data describing a low-resolution version of an image;

a metadata section including non-image metadata, wherein the non-image metadata includes information locating a high-resolution version of the image and data describing commands describing modification of the image.

The non-image metadata additionally may additionally include data describing the location of the image within a document.

### BRIEF DESCRIPTION OF THE DRAWINGS

FIG. 1 is a flow chart showing a flow of data within a first version of a prior-art OPI process;

FIG. 2 is a flow chart showing a flow of data within a second version of a prior-art OPI process;

FIG. 3 is a flow chart showing a flow of data within a prepress process in accordance with the present invention;

FIG. 4 is a pictographic view of a data structure within a low-resolution data file generated within a page layout program within the process of FIG. 3;

FIG. 5 is a schematic view of a first example of a system performing the prepress process of FIG. 3;

FIG. 6 is a schematic view of a second example of a system performing the prepress process of FIG. 3;

FIG. 7 is a flow chart showing processes occurring within a page layout program within the system of FIG. 3, comprising an upper potion, indicated as FIG. 6A, and a lower portion, indicated as FIG. 6B;

FIG. 8 is a flow chart showing processes occurring within a page layout program within the system of FIG. 3; and

FIG. 9 is a schematic view of a system using the present invention to provide remote image editing.

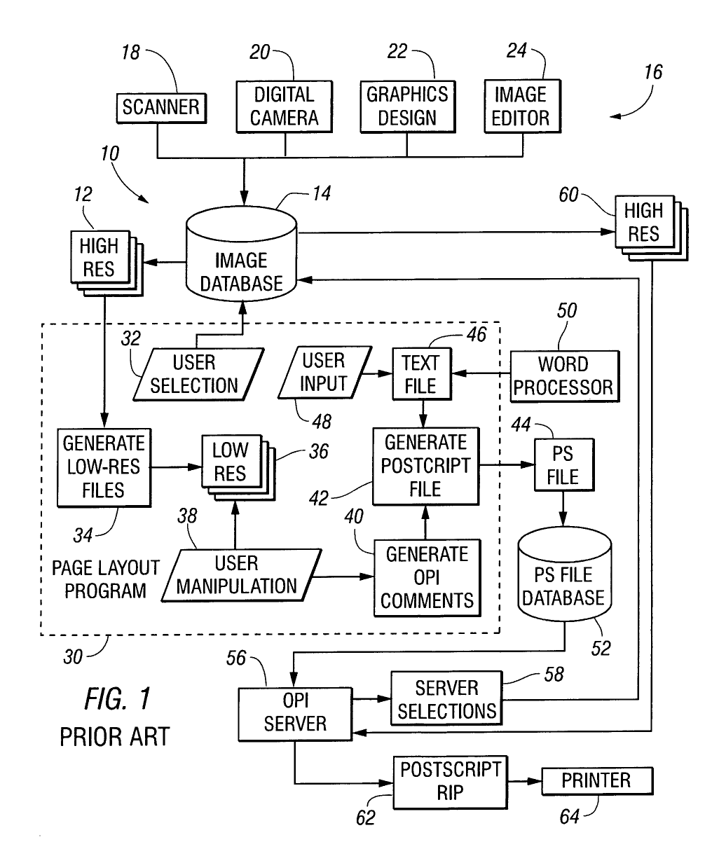

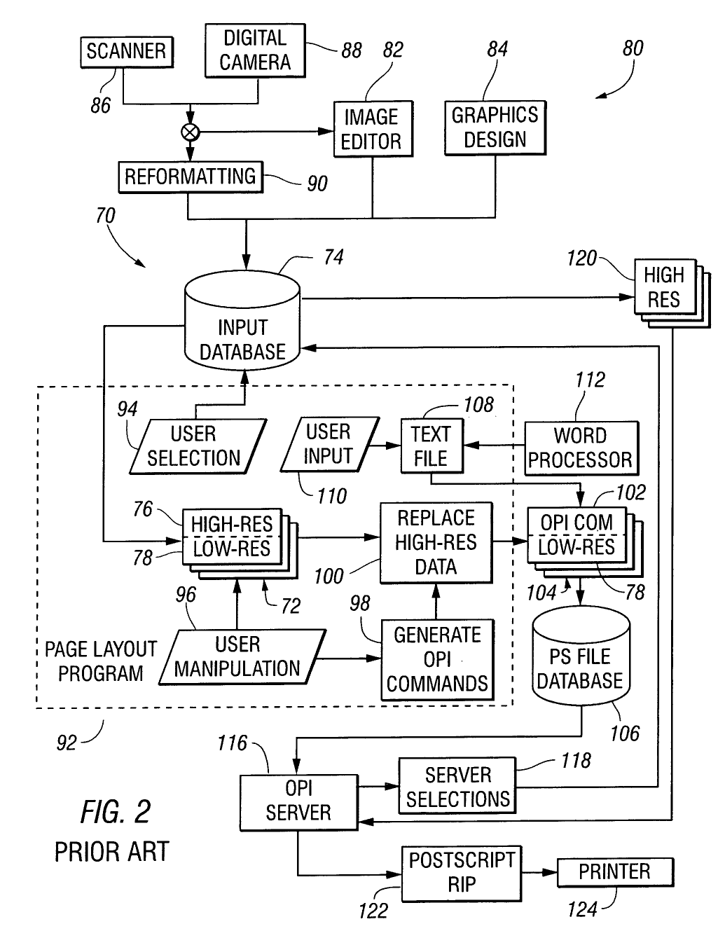

### DETAILED DESCRIPTION OF THE INVENTION

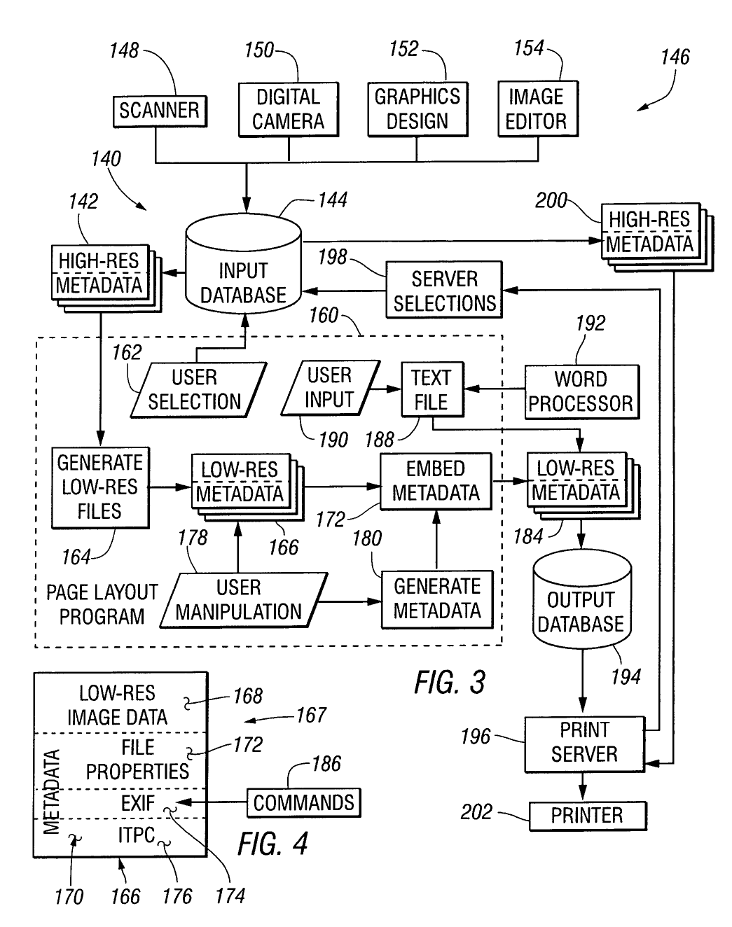

FIG. 3 is a flow chart showing a data flow within a prepress process 140 in accordance with the present invention. Input data for this process, in the form of high-resolution input data files 142, is stored in an input database 144, having been transmitted from input sources 146, such as a scanner 148, a digital camera 150, a graphics design program 152, such as Adobe® Illustrator®, or an image editor program 154, such as Adobe® Photoshop®.

A page layout program 160, configured in accordance with the present invention, is used to layout one or more pages to be printed, with the page(s) including images from the high-resolution input data files 142, selected by the user in step 162 from the files stored within the input database 144. The files stored within the input database 144 are high-resolution files, which are needed to provide a desired level of image quality for the printing process. In step 164, low-resolution data files 166 representing the images of the high-resolution images of input files 142 are generated, according to the present invention, for use as placeholders in the page layout process, since the high-resolution image is not needed for placement and manipulation.

Preferably, the high-resolution image data files 142 are written in the JPEG file format, which are converted into low-resolution data files also written in the JPEG file format 166 in step 164. Alternately, the high-resolution image data files 142 may be data files written in the TIFF file format, which are converted into low-resolution data files in step 164. The JPEG and TIFF file formats are widely recognized by various applications used in the production and printing of documents and are particularly configured to allow the transfer of data from one such application to another. Additionally, the JPEG and TIFF file formats provide for a substantial data compression, which complements the reduction in file size provided by the generation of low-resolution image data in step 164. Furthermore, both the JPEG and TIFF file formats provide sufficient room for storing metadata related to the image for which image data is stored in a file, as required for operation in accordance with the present invention.

The low-resolution image data describes an image having a resolution that is sufficient for display and manipulation but insufficient for high-quality printing. The high-resolution image data describes an image having a resolution that is sufficient for high-quality printing. For example, the low-resolution data provides a resolution less than 100 lines per inch, while the high-resolution data provides a resolution over 200 lines per inch.

FIG. 4 is a pictographic view of a data structure 167 within the low-resolution image data file 166, showing a data section 168 provided for storing image data and a data section 170 provided for storing megadata. Conventional metadata, which is embedded within digital image files, is used to provide non-image data describing the digital image. For example, conventional metadata includes data automatically generated during the process of creating the digital image file, such as data describing the file properties of the image data, stored within a first portion 172 of the metadata section 170, and data, stored within the second portion 174 of the metadata section 170, describing the input device, such as a digital camera or scanner, producing the original data. This input device data is filed according to an Exif (Exchangeable Image File Format) specification, which has been developed to provide digital camera manufacturers with a place to store data identifying the type of camera or other device used to produce the image, the camera settings, and the date and time a digital photograph was taken. The conventional metadata also includes ITPC (International Press Telecommunications Council) metadata, stored within a third portion 176 of the metadata section 170, which can be edited by the user to describe information useful in describing images to be sold, such a copyright data, conditions of use, keywords associated with the image, and a caption for the image. The conventional metadata can also be extended according to the XMP (eXtensible Metadata Platform) standard.

Referring again to FIG. 3, in step 178, the user manipulates images produced and displayed by the page layout program 160, using the low-resolution image data files 166. These manipulations, which include, for example, a placing the images on the page(s) being laid out and moving, and cropping the images are performed using tools of the page layout program 160. In step 180, the page layout program 160 generates commands, including the file name and position of each image placed on the page(s) being laid out, cropping information, and any other changes made to the data describing each image by the user in step 178. Then, in step 182, the commands generated in step 180 are embedded in the metadata section 170 of the low-resolution image data 166 to form low-resolution output files 184.

For example, as shown in FIG. 4, the commands 186 generated in step 180 may be embedded within the portion 174 of the metadata section 170, or which is conventionally reserved, or otherwise used, for storing Exif information, with the metadata tags provided for storing Exif information being used to store individual commands 116, without adding additional metadata tags. Since the output data file 184 is only used to carry image modification information between the page layout program 160 and the print server 196. a failure to provide the conventional metadata in the data structure 167 should not present a problem.

If text is to be included within the page(s) being laid out, a text file 188 is generated within the page layout program 160, either using input data provided by the user in step 190 through the keyboard (not shown) of the computer system executing the page layout program 160 or through the importation of text data from a word processor 192.

The output file 184 is stored within a database 194 to be loaded into a print server 196 when the server 196 becomes available. Then, when the print server 196 receives the output file 184, the commands 186 are extracted from the embedded metadata, and the file names associated with the images that are used in the page(s) to be printed are used to define server selections 198 from high-resolution files stored within the input database 144. The selected high-resolution files 200 are then transmitted to the print server 196 where layout information from the commands 186 is used to modify images derived from the selected high-resolution data files 198 and to place these images within data representing the files to be printed. The print server generates these files to be printed in a format, such as a JPEG or TIFF format, that can be read by the printer 202, to which the files are then transmitted.

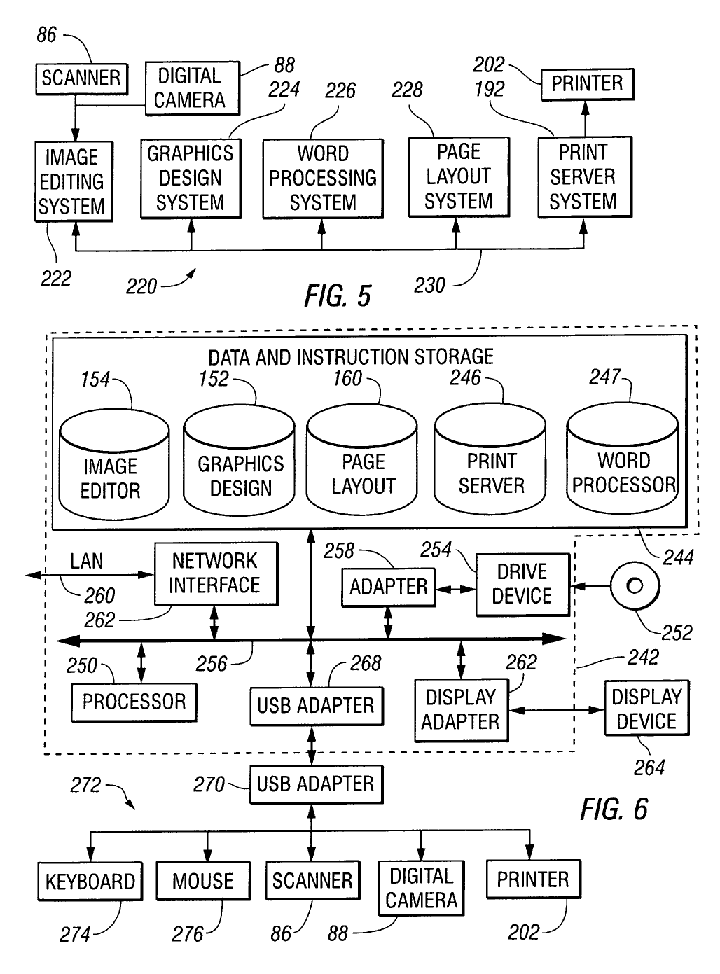

FIG. 5 is schematic view of a system 220 forming a first example of a system performing the prepress process of FIG. 3 to which reference is additionally made. The system 220 includes an image editing system 222, connected to the scanner 86 and the digital camera 88, and executing the image editor program 82; a graphics design computer system 224, executing the graphics design program 152; a word processing system 226, executing the word processing program 152, a page layout computer system 228 executing the page layout program 160; the print server system 196, and the printer 202. The systems 222, 224, 226, 228,192 are interconnected by a LAN 230 (local area network) for the transmission of data.

FIG. 6 is a schematic view of a second example 240 of a system performing the prepress process of FIG. 3. The system 240 includes a single computer system 242 including data and instruction storage 244 storing the image editor program 154, the graphics design program 152, the page layout program 160 and a print server program 246. The data and instruction storage 244 also stores data produced during the execution of one of the programs 154, 152. 160, 246 for later use another of the application programs. The computer system 242 additionally includes a processor 250 executing instructions of the various programs stored within data and instruction storage 244 and reading and writing data stored therein. Program instructions and data from a computer readable medium 252, such as an optical disk, may be read through a drive device 254 connected to a bus 256 within the computer system through an adapter circuit 258, Additionally, program instructions and data from a data signal transmitted along a LAN 260 may be received through a network interface circuit 262 for storage within data and instruction storage 244. Data and instruction storage 244 is considered to be a computer readable medium. The computer system 242 additionally includes a display adapter 262, through which a display device 264 is attached to the bus 256, and a USB adapter 268, through which a USB hub 270 is attached to the bus 256. The printer 202, and input devices 270, including a keyboard 275, a mouse 276, the scanner 86, and the digital camera 88, are attached to the USB hub 270.

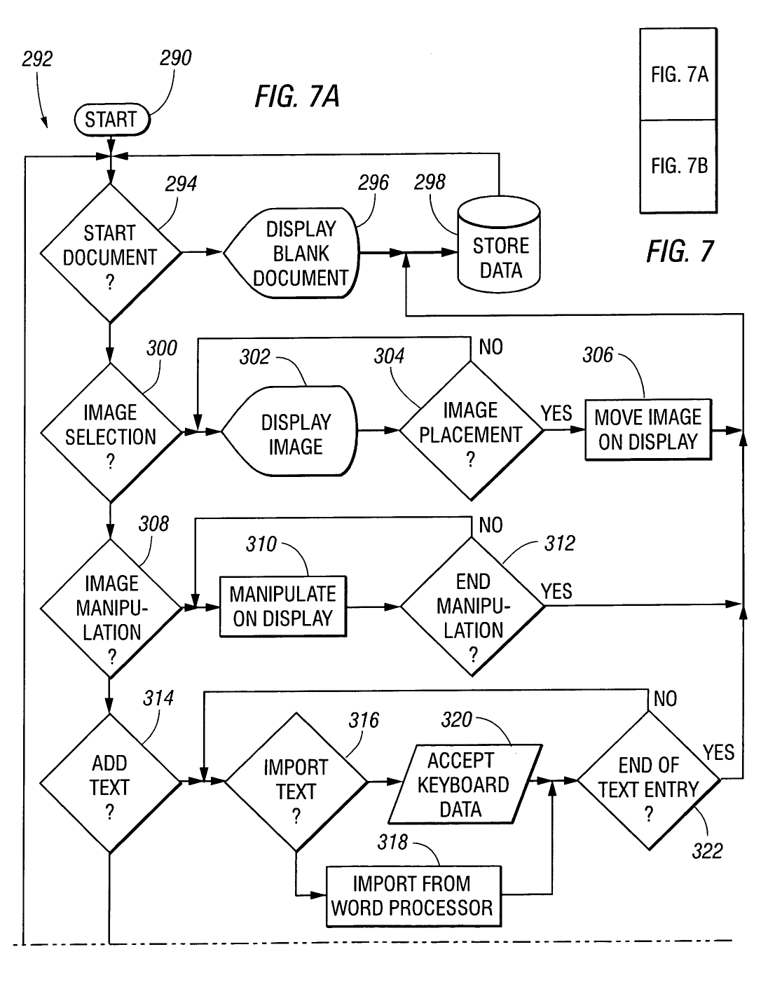

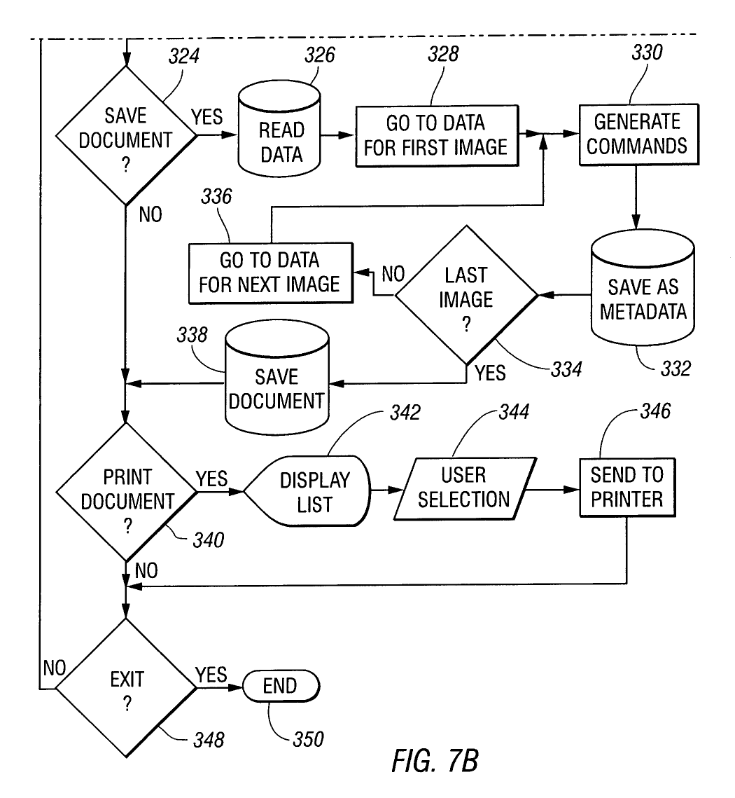

FIG. 7, which includes an upper portion, indicated as FIG. 7A, and a lower portion, indicated as FIG. 7B, is a flow chart showing processes occurring within the page layout program 160. After starting in step 290, the program 160 enters a loop 292, waiting for the user to make a selection. Within the loop 292, if it is determined in step 294 that the user has selected to start forming a new document, a blank document is displayed in step 296, with data defining the document being stored in step 298. Then, the program 160 returns to the loop 292. If it is determined in step 300 that the user has selected an image to place in the document, the selected image is displayed in step 302. If it is then determined in step 304 that the user has placed the image on the document in a particular location, for example by selecting the location with a mouse, the image is moved into the selected location in step 306. Then, the program 160 returns to step 298 to store data describing the selected location.

The page layout program 160 preferably displays a number of tools that can be used to manipulate an image being displayed. For example, a cropping tool may be used to remove portions of the image, and a resizing tool may be used to change the size of the image. Other tools may be provided for other types of image manipulation, such as changing the tone and contrast of the image. When one of these tools is selected by the user, it is determined in step 308 that the user has selected a tool for manipulation. As the program 160 then receives user selections corresponding to the use of the tool, the image is correspondingly manipulated on the display in step 310. When it is then determined in step 312 that the user has ended the manipulation of an image using a particular, for example by releasing a mouse button that is held down during the manipulation process, data describing the manipulations that have been made is stored in step 298.

If it is determined in step 314 that the user has selected a tool to add text to the document being prepared, a further determination is made in step 316 of whether the user has selected to import a text file generated, for example, using a word processor. If he then selects a text file to import, the text file is imported in step 318. Otherwise, the text is generated from keyboard data accepted in step 320. When it is then determined that the user has ended the entry of text in step 322, data representing the text that has been added is stored in step 298.

The user can repeatedly use various tools of the program 160 to place multiple images in a document including one or more pages. The user can, for example, return to previously selected and manipulated images to move the images around in the document and to make further manipulations. The user can then select to save the document. When it is then determined in step 324 that the user has selected to save the document, all of the data that has been saved regarding the document in step 298 is read in step 326. Then, in step 328, the program 160 goes to the data read in step 326 corresponding to the first image. Next, in step 332, the commands for placement and manipulation of the first image are recorded as metadata in the data file of the first image. Then, in step 334, a determination is made of whether the image for which metadata has just been recorded is the last image. If it is not, the program 160 goes to the data for the next image in step 336 and returns to step 330 to repeat this process until it has been performed on the data of each image, as determined in step 334. Then, the document, with all the commands having been added as metadata to each the data for each image, is saved in step 338.

When it is determined in step 340 that the user has selected to print a document for which information has been saved in step 338, a list of such documents is displayed in step 342, allowing the user to select a document in step 344 for sending to the printer in step 346. For example, as described above in reference to FIG. 7, the step 346 of sending data to the printer includes storing the data in an output database to wait for the print server 196 to be ready to receive the data.

If it is determined in step 348 that the user has chosen to exit the program 160, the program is ended in step 350. Otherwise, the program 160 returns to step 290, continuing operation in the loop 292 to wait for another user selection.

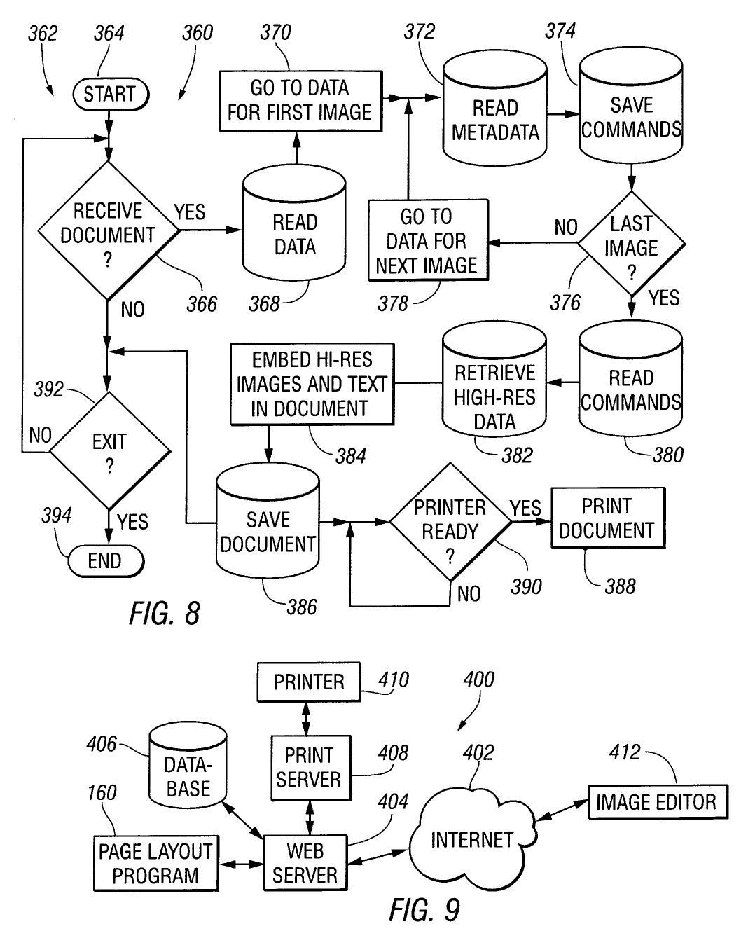

FIG. 8 is a flow chart showing processes occurring within a page layout program 360 executing within the print server 196 described above in reference to FIG. 3. After starting in step 362, the program 360 enters a loop 364 waiting to receive a document for printing. When it is determined in step 366 that a document has been received, the data from the document is read in step 368. This data includes image data, megadata, and, if text is included within the document, text data. Then, in step 370, the program 360 goes to the portion of the document data read in step 368 corresponding to the first image. In step 372, the metadata from the data file corresponding to the first image is read, and, in step 374 the commands from the metadata are saved. In step 376, a determination is made of whether the image for which commands have been just saved is the last image in the document. If it is not, the program goes to the data corresponding to the next image in step 378, and returns to step 372 to read megadata for this image. This process is repeated until the commands for each image in the document have been saved.

Then, after it is determined in step 376 that commands for the last image have been saved, all of the commands that have been saved for images in the document are read in step 380. These commands include addresses or file names locating high-resolution data for each of the images within the input database 144, shown in FIG. 3, allowing this data to be retrieved in step 382. Next, in step a document file is generated, preferably in a JPEG or TIFF file format, for printing. This document file includes embedded high-resolution data for each of the images, placed and modified according to the commands read in step 380, and text data read in step 368. Next, in step 386, the document file generated in step 384 is saved for printing in step 388 following a determination in step 390 that the printer is ready.

Preferably, the program 360 returns to the loop 362 as soon as the document data is saved in step 386 to wait for a new document to be received. Additionally, in the loop 362, a determination is made in step 392 of whether a system operator has chosen to exit the program 360, causing the program to end in step 394.

The use of flexible and widely-accepted file formats in the present invention provides a number of advantages over the OPI processes of the prior art. For example, the low-resolution output file 184, shown in FIG. 3, can be transmitted over the Internet, viewed within a web browser, and downloaded to form part of a web page. This output file can be used in any application using JPEG or TIFF files and embedded in a PDF file for printing. For example, one or more of the low-resolution output files can be used within an image editing program not recognizing the commands embedded within the metadata of the files to produce document files that can be printed by a print server executing the program 360, with the high-resolution data files corresponding to the images being located according to information stored within the metadata, and with the images additionally being modified for as described in the megadata. For the data files to be used in this way, it is only necessary that the command structure within the metadata be left intact by the image editing application, or alternately that such information will be read before modification and re-recorded in its original form after modification. Such a document should be created in a vector fashion, so that the original content is retained without creating a gigantic flat file. For example, a Vector PDF workflow or a Kodak® DP2 workflow can be established, retaining the metadata information of the images, with the print server 196, also shown in FIG. 3, operating as part of the Vector PDF workflow or a Kodak® DP2 workflow. Thus, various types of image editing programs can be used to support the page layout process without having an understanding of the operations associated with printing.

FIG. 9 is a schematic view of a system 400 using the present invention to provide remote image editing. The system 400 includes a page layout program 160, as described above in reference to FIG. 3, connected to the Internet 402 through a web server 404 to ransmit and receives data. The web server 404 is also connected to a database 406 and a print server 408. which is in turn connected to a printer 410. The database 406 includes high-resolution image data files 142, shown in FIG. 3, which are provided as inputs to the page layout program and low-resolution image data files 184, which are transmitted as outputs from the page layout program 160, operating as described above in reference to FIG. 3. These low-resolution images may be sent to the print server 406, executing the print server program 160, as described above in reference to FIG. 8, to read metadata and print documents on a printer 408, with the print server 408 accessing the high-resolution data files 184 through the web server 404.

The system 400 additionally includes an image editor 412, executing a conventional editing program to produce documents including images represented by data processed through the page layout program 160. For example, image data is provided from the database 406 for thumbnail viewing over the Internet 402. The user of the image editor 412 selects the images to use from these thumbnails and downloads the low-resolution image data 184 associated with these images. The user of the image editor 412 then uses these files for document creation, and has prints made using the print server 408. It is important that the metadata including commands for modifying the selected images is left intact during operations in the image editor 410, or alternately this metadata is read before such operations and subsequently rewritten. For example, the print server 408 may be located over the Internet using a URL (Uniform Resource Locator) embedded in the low-resolution files 184. After receiving the document data sent over the Internet from the image editor 410, the print server 408 uses the commands stored within the metadata to select the high-resolution image data 142 stored within the database 406 to replace the corresponding low-resolution image data files 184, and to modify the high-resolution data as according to manipulations performed within the page layout program 160.

Since the image editor 412 operates in a conventional manner, without an understanding of processes unique to the present invention, it has no ability to provide an indication of image placement through the addition of data indicating commands to the metadata of the low-resolution image data files. Therefore, a document data file including the low-resolution image data embedded in locations determined using the image editor 412 is sent to the print server 408, along with the low-resolution image data files 184. After the print server 408 receives this document data file, it bases the placement of high-resolution images in step 384 of FIG. 3 on the placement of the low-resolution images in the document data file.

With the present invention, the benefits of prior-art OPI processing are achieved without a need for a PostScript printer and without other limitations of the PostScript process.

While the invention has been described and shown in its preferred embodiments with some particularity, it is understood that this description has been given only by way of example, and that variations can be made without departing from the spirit and scope of the invention, as defined in the appended claims.

What is claimed is:

1. A method for preparing prepress image data, wherein the method comprises:
receiving a user selection of a plurality of images;
loading a high-resolution input data file for each image within the plurality of images, wherein each of the high-resolution data files includes an image data section storing data describing a high-resolution version of the image;
receiving user inputs selecting images within the plurality of images within a document, and displaying the images selected, derived from the data describing a low-resolution version of each images,
generating a low-resolution input data file corresponding to each of the high-resolution data files, wherein each of the low-resolution data files includes an image data section, storing data describing a low-resolution version of the image, and a metadata section for storing non-image data;
receiving user inputs modifying the images displayed on a display of the document, modifying displayed versions of the images according to the user inputs modifying the images, and generating commands describing modifications of the images; and
forming a low-resolution output data file for each image by embedding data describing the commands describing modifications of the image and information describing a location of a high-resolution image file including data describing a high-resolution version of the image in the metadata section of the low-resolution image data file additionally having the image data section storing data describing a low-resolution version of the image.

2. The method of claim 1, additionally comprising:
receiving user inputs placing images within the plurality of images within a document, displaying the images, derived from the data describing a low-resolution version of each images, on a display of the document according to the user inputs, and generating commands describing the placement of images according to the user inputs;
embedding data describing the commands describing the placement of each image within the document in the metadata section of the low-resolution image data file additionally having the image data section storing data describing a low-resolution version of the image within the low-resolution output data file.

3. The method of claim 2, additionally comprising:
reading the data describing the commands describing the placement of each image within the document, the data describing the commands describing modifications of the image, and the information describing a location of a high-resolution image file including a high-resolution version of the image from the metadata section of each low-resolution data file;
retrieving the high-resolution image file including a high-resolution version of the image using information read from the metadata of each low-resolution data file; and
generating a document data file for printing including an embedded high-resolution image file for each image, located and modified according to commands read from the metadata of each low-resolution data file.

4. The method of claim 1, additionally comprising:
transmitting a plurality of the low-resolution output data files over a network to an image editing system at a remote location
generating a document data file including an embedded low-resolution version of each image stored within the low-resolution output data files within the image editing system;
transmitting the document data file and the low-resolution output data files to a print server system;
reading, within the print server system, the data describing the commands describing modifications of the image, and the information describing a location of a high-resolution image file including a high-resolution version of the image from the metadata section of each low-resolution data file;
retrieving the high-resolution image file including a high-resolution version of the image using information read from the metadata of each low-resolution data file; and
generating a data file for printing including an embedded high-resolution image file for each image, located according to the location of the embedded low-resolution version of each image within the document data file and modified according to commands read from the metadata of each low-resolution data file.

5. The method of claim 4, additionally comprising, before transmitting the plurality of low-resolution output data files to the image editing system,
transmitting thumbnail versions of available low-resolution output data files to the image editing system at a remote location for viewing and selection; and
receiving a selection of thumbnail images indicating low-resolution data files to be transmitted to the image editing system.

6. The method of claim 1, wherein the commands are embedded within a portion of the metadata conventionally reserved for storing Exif data describing a device used to form the image, without adding metadata tags.

7. The method of claim 1, wherein each of the data files is written in a file format providing data compression, taken from a group consisting of the JPEG file format and the TIFF file format.

8. A memory for storing data for access by an application program being executed on a computer system, comprising a data structure stored in the memory, the data structure including:
an image data section including image data describing a low-resolution version of an image;
a metadata section including non-image metadata, wherein the non-image metadata includes information locating a high-resolution version of the image and data describing commands describing modification of the image.

9. The memory of claim 8, wherein the non-image metadata additionally includes data describing the location of the image within a document.

10. The memory of claim 8, wherein the commands are embedded within a portion of the metadata section conventionally reserved for storing Exif data describing a device used to form the image.

11. The memory of claim 8, wherein the commands are embedded within a portion of the metadata conventionally reserved for storing Exif data describing a device used to form the image, without adding metadata tags.

12. The memory of claim 8, wherein the data structure is written in a file format providing data compression, taken from a group consisting of the JPEG file format and the TIFF file format.

13. A computer program product including a computer readable medium storing computer readable code causing a processor within a computer system to perform a method comprising:
receiving a user selection of a plurality of images;
loading a high-resolution input data file for each image within the plurality of images, wherein each of the high-resolution data files includes an image data section storing data describing a high-resolution version of the image;
receiving user inputs selecting images within the plurality of images within a document, and displaying the images selected, derived from the data describing a low-resolution version of each images,
generating a low-resolution input data file corresponding to each of the high-resolution data files, wherein each of the low-resolution data files includes an image data section, storing data describing a low-resolution version of the image, and a metadata section for storing non-image data;
receiving user inputs modifying the images displayed on a display of the document, modifying displayed versions of the images according to the user inputs modifying the images, and generating commands describing modifications of the images; and
forming a low-resolution output data file for each image by embedding data describing the commands describing modifications of the image and information describing a location of a high-resolution image file including data describing a high-resolution version of the image in the metadata section of the low-resolution image data file additionally having the image data section storing data describing a low-resolution version of the image.

14. The computer program product of claim 13, wherein the method additionally comprises:
receiving user inputs placing images within the plurality of images within a document, displaying the images, derived from the data describing a low-resolution version of each images, on a display of the document according to the user inputs, and generating commands describing the placement of images according to the user inputs;
embedding data describing the commands describing the placement of each image within the document in the metadata section of the low-resolution image data file additionally having the image data section storing data describing a low-resolution version of the image within the low-resolution output data file.

15. The computer program product of claim 13, wherein the commands are embedded within a portion of the metadata conventionally reserved for storing Exif data describing a device used to form the image, without adding metadata tags.

16. The computer program product of claim 13, wherein the data files are written in a file format providing data compression, taken from a group consisting of the JPEG file format and the TIFF file format.

17. A computer program product including a computer readable medium storing computer readable code causing a processor within a computer system to perform a print server method comprising:
receiving a plurality of image data files, wherein each of the image data files comprises an image data section, including image data describing a low-resolution version of an image, and a metadata section, including non-image metadata, wherein the non-image metadata includes information locating a high-resolution version of the image and data describing commands describing modification of the image;
reading the data describing the commands describing the placement of each image within the document, the data describing the commands describing modifications of the image, and the information describing a location of a high-resolution image file including a high-resolution version of the image from the metadata section of each low-resolution data file;
retrieving the high-resolution image file including a high-resolution version of the image using information read from the metadata of each low-resolution data file; and
generating a document data file for printing including an embedded high-resolution image file for each image, located and modified according to commands read from the metadata of each low-resolution data file.

18. The computer program product of claim 17, wherein
the metadata section of each of the image data files additionally includes data describing the location of the image within a document, and
the print server method additionally includes reading the image data files including data describing the location of the image within a document and locating the embedded high-resolution image files within the document data file according to the data describing the location of the image.

19. The computer program product of claim 17, wherein the print server method additionally includes:
receiving a document data file including embedded low-resolution image files representing the images; and
locating the embedded high-resolution image files within the document data file according to the locations of the low-resolution image files.

20. The computer program product of claim 17, wherein the commands are embedded within a portion of the metadata conventionally reserved for storing Exif data describing a device used to form the image, without adding metadata tags.
